(19) United States
(12) Patent Application Publication
(10) Pub. No.: US 2005/0064143 A1
(43) Pub. Date: Mar. 24, 2005

(54) Formation of sheet material using hydroentanglement

(76) Inventor: Christopher Graham Bevan, Stamford (GB)

Correspondence Address: KOPPEL, JACOBS, PATRICK & HEYBL, 555 ST. CHARLES DRIVE, SUITE 107, THOUSAND OAKS, CA, 91360, US

(21) Appl. No.: 10/494,475

(22) PCT Filed: Nov. 29, 2002
(86) PCT No.: PCT/GB02/05381

(30) Foreign Application Priority Data
Nov. 30, 2001 (GB) 0128692.1

(51) Int. Cl. B29C 43/10; B32B 1/00

(52) U.S. Cl. 428/151; 264/500; 264/319; 428/85; 428/152

(57) ABSTRACT

Sheet material is made from a mixture of base fibres, such as leather fibres, and bi-component synthetic fibres which have outer layers which melt at a lower temperature than their inner cores. The fibres are mixed, formed into a web and then heated so that the synthetic fibres fuse together to form a network within the web. The base fibres are then tangled, whilst constrained by the network, preferably using hydroentanglement. A high quality reconstituted leather sheet material can be produced.

This invention relates to the formation of sheet material from fibres particularly using a process known as hydroentanglement or spunlacing.

Prior patent application PCT/GB 01/02451 describes the use of hydroentanglement (or spunlacing) to produce a high quality reconstituted leather sheet material from waste leather fibres.

A feature of the procedure described in the prior application is the use of specialised screens through which hydroentangling jets are directed at high pressure, in contrast to previously known procedures where entangling commences at low pressure until the fibres are sufficiently interlocked to avoid disruption by the jets. Leather fibres entangle particularly readily, and with previously known procedures, they form a surface layer of entangled fibres that impedes further entanglement. This is particularly disadvantageous with thick webs needed for leather products but by using the aforesaid screens, jets can penetrate deeply at high pressure to hydroentangle throughout the depth of the web.

The difficulties with disruption and the formation of a surface layer arise because fibres resulting from the disintegration of waste leather are far shorter and finer than those normally used for hydroentangling. The screens of the prior patent application provide a means of constraining such fibres from being washed away by the jets, but even with screens it is difficult to constrain very short fibres such as are produced by hammer milling waste leather. Also, whatever the length of fibres about half the hydroentangling energy is wasted when using screens due to the solid parts of the screen shielding significant area of the web from the jets. The loss of energy when using screens and the lower output rates from using leather fibres of greater length are inherent with the procedure of the prior application.

An object of the present invention is to provide a method of entangling fibres to form sheet material whereby the aforesaid problems arising from use of screens and longer fibres can be avoided or at least minimised.

According to one aspect of the invention therefore there is provided a method of forming a sheet material from a mixture of fibres comprising base fibres and additional synthetic fibres, said synthetic fibres having outer meltable layers, comprising the steps of:
forming the fibres into a web,
heating to melt the outer layers of the additional synthetic fibres so as to cause such fibres to fuse together at intersections to form a network within the web,
subjecting the web to entanglement to entangle the base fibres whilst constrained by the network.

Preferably, the entanglement is hydroentanglement. Preferably also the base fibres are leather fibres.

Thus, in accordance with a second aspect of the invention there is provided a method of forming a sheet material from a mixture of fibres comprising leather base fibres and additional synthetic fibres, said synthetic fibres having outer meltable layers comprising the steps of:
forming the fibres into a web,
heating to melt the outer layers of the synthetic fibres so as to cause such fibres to fuse together at intersections to form a network within the web,
subjecting the web to hydroentanglement to entangle the leather fibres whilst constrained by the network.

The entanglement of the method of the invention is preferably performed using high pressure jets of liquid (particularly water) preferably in multiple passes. Reference is made to the prior application for further details of such features.

In a preferred embodiment, the invention provides a method of forming sheet material with a mixture of leather fibres and man made bicomponent fibres, said bicomponent fibres having outer layers with a lower melting point than the inner cores. The mixture of fibres is formed into a web, which advances through a heating means that melts the outer layers of the bicomponent fibres so they fuse at their intersections, and form a three dimensional network throughout the web. Fine jets of water at high pressure are then directed onto the web so they penetrate deeply and hydroentangle the leather fibres while these are constrained by the network of bicomponent fibres.

Fused bicomponent supporting networks are known but not in the context of the present invention.

Such networks are used in conjunction with wood pulp fibres to impart most or all of the finished product strength for applications such as wet wipes and absorbent sanitary products. The high pressure jets used in hydroentanglement would disrupt the bonding of such network and, where such networks are used with hydroentanglement, the bicomponent fibres are fused after hydroentanglement, thereby avoiding such disruption. With the present invention the network is used for a different purpose to that of providing structural reinforcement for the end product, and entanglement is effected after fusing.

A basic requirement of entangling is that fibres must move in order to entangle, and the fused network would be expected to impede the entanglement of the fibres. Surprisingly, it has been found that leather fibres can entangle effectively within such networks even if the apparent restraining effects are enhanced by compressing the webs containing the leather and bicomponent fibres while the surfaces of the bicomponent fibres are still tacky, thereby presenting a significantly denser layer to the hydroentangling jets.

With the arrangement of the invention, the network can take over part or all of the function of the external screens used in the method of the prior patent application. However, instead of acting on the surface, the network can provide a succession of much lighter screens within the depth of the web. Each internal screen can have relatively much more open area than an external screen, but collectively they can provide an effective and improved alternative to the external screen of the prior application. In particular the network of internal screens allows hydroentangling jets to penetrate deeply at pressures that would otherwise disrupt the web.

Apart from replacing the function of the screens, the bicomponent network can also improve the way the leather fibres hydroentangle. One of the difficulties of hydroentangling leather fibres is that even when using screens they consolidate so readily that they impede drainage of water through the web and the resulting flooding can prevent optimum entanglement. However, the three dimensional structure of the bicomponent network can even out the rate of consolidation of the web, which together with the deep penetration can assist the drainage of water through the web until full entanglement is achieved.

It is believed that this drainage effect is achieved by the three-dimensional network of bicomponent fibres providing a resilient restraint to compaction within the body of leather fibres. It is desirable to ensure that the network does not hold the leather fibres away from each other to the extent that there is insufficient proximity for them to entangle well with each other since this could result in a spongy material less desirable for leather products. This effect can be reduced or prevented by reducing the quantity of bicomponent fibres in the mix and/or using bicomponents of lower diameter and/or lower elastic modulus.

In normal hydroentangling practice most of the fibres can start off too far apart to entangle effectively, and a first pass through the jets is used to bring the fibres close enough to entangle. In a preferred embodiment of the present invention, the fibres are brought into closer proximity before entangling commences by compressing the web containing the bicomponent network before the fused junctions of the network solidify. This can more than halve the thickness of the web compared to conventional practice and can effectively eliminate the first hydroentangling stage used in conventional practice.

In the method of the prior application the external screen helped to compress the web at the first stage of entanglement, but this can incur significant loss of hydroentangling energy because of the surface area of the web being shielded from the jets. However in the present invention the solid parts of the internal bicomponent screens can be relatively insubstantial so there can be substantially less shielding of hydroentangling jets from the fibres. This can reduce the number of passes needed by the jets over the web to achieve full entanglement and reduce the energy consumed. Typical production speeds can also increase from 6 m/min mentioned in the prior application to over 10 m/min in the present invention.

Being relatively fine, the bicomponent network may be less effective than externally applied screens for masking the furrows in the surface caused by the jets. Accordingly, with the method of the present invention external screens may additionally be used (which may be generally of the kind described in the prior application) in at least one pass to eliminate or at least reduce or substantially prevent formation of surface furrows by the hydro-entanglement jets. In so far as the bicomponent network acts as a series of internal screens, externally applied screens can have more open area than the preferred openings described in the prior patent application thereby reducing the loss of energy. Such external screens still waste some energy, but they can be confined to passes where they are needed to mask jet lines. Typically this can be the last pass on the finish face, and possibly the first pass so that the jets bite less deeply while the fibres are least entangled.

The prior patent application describes a method for producing long leather fibres to improve performance of the finished product but such fibres also pass more slowly through the preferred equipment for air-laying the webs. However with the present invention, short leather fibres can be used without necessarily adversely affecting product performance because the network can reduce or eliminate some of the defects that arise with short leather fibres. For example, products made with short leather fibres are more liable to surface cracking, but short bicomponent fibres may still be beneficially used to enhance throughput from web laying equipment, as by fusing the bicomponent fibres to form a network, they act like much longer fibres and thereby more effectively constrain surface cracking. Short fibres are also more prone to erosion during hydroentangling, but the network of fused bicomponent fibres can considerably reduce this without interfering with the relatively small movements needed for hydroentanglement.

Unlike other fields of manufacture where short bicomponent fibres are fused at their intersections, the contribution of bicomponent fibres to primary strength can be negligible, and the proportion of such fibres in the total mix can preferably be minimised as they can seriously detract from leather-like handle. In cases where the performance of products made with short fibres needs to be significantly upgraded this can be achieved by incorporating normal, non-bicomponent fibres with a reduced proportion of bicomponent fibres.

The proportion of bicomponent fibre needed to provide the purely process benefits of the present invention can be as low as 2% of the total weight of web, and can be many times less than the percentage used in conventional applications where a bicomponent network is a primary source of strength. Apart from unacceptably increasing stiffness and coarsening the surface feel of the final product, a bicomponent network that provides significant structural contribution may reduce the attachment of leather fibres to internal reinforcing fabrics by impeding the leather fibres from locking into the interstices of the fabric.

Because of these limitations, in a preferred embodiment of the present invention bicomponent fibres are used with weak outer sheaths to promote a partial breakdown of the network as the web progresses through successive stages of hydroentangling. With each pass the increased entanglement of the leather fibres can compensate for the reduction of bonds between bicomponent fibres, and can result in end products with minimal stiffening from the network. Such a procedure would be a disadvantage in conventional practice but, as with the externally applied screens of the prior application, the main purpose of the network is to overcome processing problems peculiar to hydroentangling rather than providing structural strength.

Processing benefits of the bicomponent network also extend to producing the webs themselves, particularly with commercially available equipment normally used for air laying wood pulp fibres. Such processes can have high rates of production for short fibres like wood pulp, and the bicomponent network can significantly reduce the erosion of short fibres under hydroentanglement. This allows short leather fibres such as produced by hammer milling to be hydroentangled much more effectively than by the methods of the prior application.

A further processing advantage of bicomponent networks is that they can provide sufficient strength to the web before hydroentangling to allow webs to be wound onto reels at interim stages of production. This removes the need to feed webs directly from the air laying equipment to the hydroentangling line as in the method of the prior application, and allows the webs to be produced at optimum speeds determined by the air laying equipment without compromising the operation of the hydroentangling line. Thus, in one embodiment the (or each) web is wound on a reel after formation of the network, and the web is drawn from such reel to be subjected to said entanglement.

Furthermore, where the product requires two webs on either side of a reinforcing fabric, both webs can be formed using one air laying plant. Two reels of webs stabilised with bicomponent networks can then be fed to the hydroentangling line, and can result in a substantial saving of capital cost compared to the method of the prior application where two entire air laying means were required to continuously feed the hydroentangling line. Where a reinforcing fabric is used the base (leather) fibres preferably penetrate this so as to be entangled therewith.

The fibre content needed to provide adequate reel handling strength depends on web thickness, bicomponent content and the strength of the melt-able sheath on the bicomponent fibres. However, generally the percentage of bicomponent fibre needed to impart sufficient in-process strength for reel winding need be no more than the same low bicomponent content that can provide effective internal screens in the method of the present invention. This in-process strength for individual webs is well below the strength after hydroentangling, particularly after hydroentangling webs and reinforcing fabric to form a final product.

As with most fibrous products, fibre length preferably needs to be as long as possible. However, long leather fibres produced by textile reclaiming methods have a wide distribution of fibre length from around 1 mm to occasionally over 15 mm, and the upper end of the distribution can cause very slow production rates using air laying equipment designed for wood pulp fibres. It can therefore be preferable to limit the maximum length of such fibres to around 6 mm, for example by passing them through a conventional granulating machine (taking care to avoid shortening more than necessary to make a worthwhile improvement in air laying output). Such methods of shortening fibres can be very approximate, but preferably at least 90% of the fibres should be less than 6mm for efficient air laying. Thus, in the method of the invention, in order to obtain improved throughput from air-laying equipment designed for wood pulp fibres, at least 90% of the base fibres have a maximum fibre length of 6 mm.

In the case of hammer milled leather fibres there is also a wide distribution of fibre lengths, but lengths are generally much less than produced by textile reclaiming methods. Typically the maximum length may be around 3 mm and, as with fibres produced by textile reclaiming methods, the average fibre length is significantly less than the maximum. No granulation is required for hammer milled fibres, but the much shorter length can result in a need to increase average length of the mix by adding manmade fibres of predetermined optimum length in order to improve the physical properties of the final product.

Unlike leather fibres, manmade fibres can be chopped to a constant length so they can all be of a length that provides the optimum balance between air laying throughput and performance of the finished product. For air laying equipment designed for wood pulp, the length of manmade inclusions may be around 6 mm, but recent improvements in air laying technique may make it feasible to increase this to over 10 mm. These indicative fibre lengths apply typically to bicomponent and non-bicomponent manmade fibres in the 1.7 dtex to 3.0 range. Finer fibres can significantly reduce air laying output unless fibre length is reduced appropriately.

Air laying speeds vary considerably depending not only on fibre length and diameter, but also on the smoothness and shape of fibres. In these respects leather fibres are particularly unfavourable regarding air laying throughput, as they are usually curly and have finely fibrillated branches that can impede flow through the perforated distribution screens of air laying equipment. Air laying rate for un-granulated leather fibres produced by textile reclaiming methods can be as low as 3 m/min for a 200 gsm web, but this can be more than doubled if the fibres are shortened. Laying rates for manmade and pulp fibres can be considerably faster.

Regarding the percentage of bicomponent fibre in the mix, it is generally preferable to keep this to the minimum as described earlier. The degree to which the bicomponent network compromises leather-like handle depends on end use, and for shoes the greater stiffness and wearing properties conferred by the bicomponent network can be more acceptable or even be of benefit compared to (for example) clothing leather. For shoes up to 10% of 3.0 dtex bicomponent can be used, but to obtain better handle it can be preferable to use under 5% bicomponent and a greater proportion of non-bicomponent fibres. In general the overall range for additional synthetic fibres is 2% to 10% by weight with a preference towards the lower end of the range.

From the viewpoint of providing effective internal screens, the number of bicomponent fibres can be as significant as their percentage by weight of total mix. For example, reducing from 3.0 to 1.7 dtex in a 5% mix would proportionately increase the number of fibres in the mix, and to obtain a similar screen effect, the percentage of 1.7 dtex fibres may need to reduce to below 3%. Using finer bicomponent fibres can also provide better surface feel to the finished product, which is an added benefit.

Commercially available bicomponent fibres are generally not less than 1.7 dtex, but end product handle can be improved by choosing bicomponents with a low elastic modulus, such as polypropylene. These usually have polyethylene melt-able sheaths that are not particularly strong but can still provide sufficient reel handling strength even at low percentage additions. As mentioned earlier some degree of bond weakness can be an advantage for some product applications as this can improve the handle of the final product. In applications where more stiffness is acceptable or required, stronger bicomponents can be used, such as polyester with nylon sheaths.

Bonding between bicomponent fibres at their intersections can be achieved by passing hot air through the web to melt the outer coating while the fibres are held between porous belts. The bond may not be strong enough to link short fibres together to contribute significantly to the tensile strength of the final product, but the bonds may be sufficient to provide an effective network for hydroentangling and enough anchorage to resist surface cracking of the finished product.

The fused intersections of the network may be at least partially disrupted by the entanglement.

Resistance to surface cracking can be enhanced by including ordinary non-bicomponent manmade fibres in the mix. Such fibres can also significantly improve peel resistance of the surface coating that is usually applied to the finished product. Furthermore, being free to move, non-bonded synthetic fibres can be more readily driven by jets into the interstices of the reinforcing fabric and thereby improve peel strength between the webs and the reinforcing fabric. This is particularly important for hard wearing shoes, and relatively high percentages of such fibres (compared to bicomponent) can be used without over-stiffening the final product.

In the case of a fabric reinforcing material having one or more webs or bodies of fibres united with the fabric, the (or each) web or body may contain a higher proportion of said further synthetic material adjacent the reinforcing layer than at the outer surface thereof.

The effect on handle of such further (non-bicomponent) fibres depends on their fineness as well as their percentage of mix, and in this respect they should preferably be not more than 1.7 dtex. For minimum effect on handle, such fibres can be into the “microfibre” range of well under 1.0 dtex, and with sufficiently fine manmade fibres, adequate handle can be maintained at over 10% of total fibre content. However reducing fineness increases the number of fibres present, which in itself can change the feel of the product. Alternatively where Improved peel resistance is more important than handle, coarser fibres can produce better all round results. Generally, for reasons of cost and detracting from the leather-like feel of the final product it is preferable to keep further synthetic fibre content to below 20% by weight of the end product sheet material. The range may be 5-20% by weight.

Particularly with coarser manmade fibres, even small percentages in the mix can detract from the characteristic surface feel of real leather, particularly as after buffing the superior abrasion resistance of manmade fibres can make them more prominent. In a further feature of the invention, hot air or other suitable heat sources are applied to the surface of the web after buffing at sufficient temperature to melt back the bicomponent fibres without adversely affecting the leather fibres. The technique exploits the high moisture retention of leather which keeps it cool, and its property of charring rather than melting when subjected to excess local heat. Any such charring can be brushed or lightly buffed away, leaving a substantially natural leather finish.

The invention will now be described further by way of example only and with reference to the accompanying drawings in which:

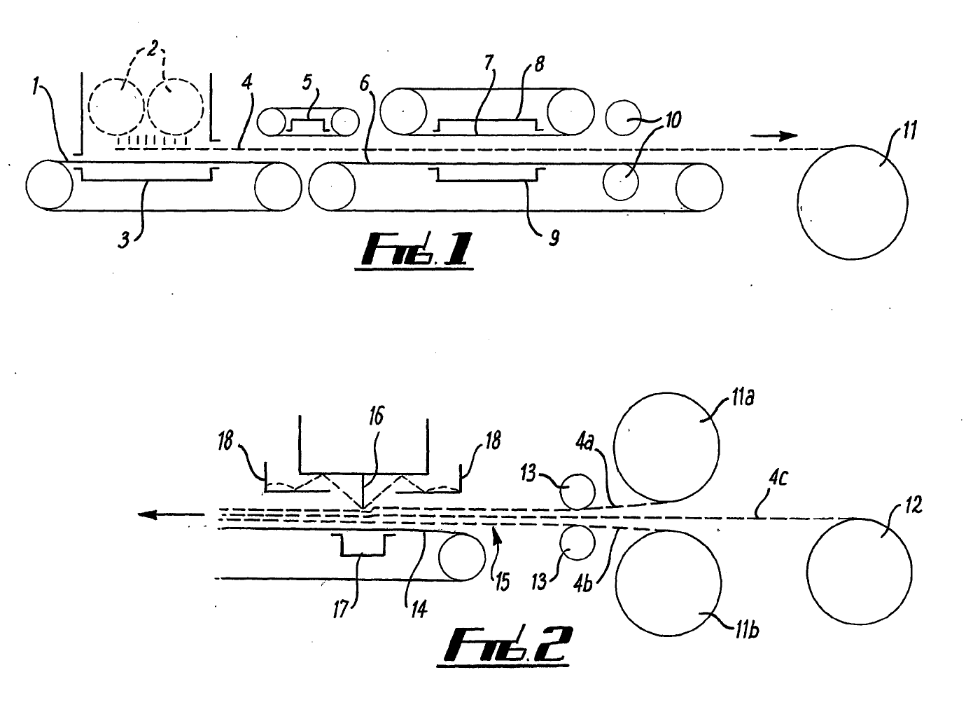

FIG. 1 is a schematic view of initial stages of one form of apparatus used in the performance of the method of the invention and which shows the main operating principles of a commercially available plant for making a fibre web with a fused bicomponent network; and

FIG. 2 shows further stages of the apparatus for combining such web with reinforcing fabric and hydroentangling the resulting sandwich.

Referring to FIG. 1, waste leather fibres made by textile reclaiming methods lightly chopped to a maximum length of approximately 6 mm are mixed with 4% of 1.7 dtex bicomponent fibres and 5% of 3.0 dtex standard polyester fibres both cut to constant 6 mm length. The mixture is evenly distributed at around 200 g/m2 onto a driven porous belt 1 by at least one pair of perforated drums 2 while the fibres are drawn onto the porous belt by vacuum box 3.

The resulting web 4 of evenly laid fibres is transferred by a conventional vacuum conveyor 5 to porous belts 6 and 7, which contain and partially compress the web while hot air from a box 8 is blown through belts 7 and 6 and web 4, and received by a suction box 9. The temperature of the hot air is sufficient to melt the outer sheath of the bicomponent fibres (but not the inner core) and thereby fuse the fibres together at their intersections.

Before the melted sheaths at the intersections of the bicomponent fibres solidify, the web may be compressed by nip rollers 10 to form a denser web consisting of un-bonded leather and polyester fibres supported by a three-dimensional network of fused bicomponent fibres. On solidification of the intersections the network provides sufficient strength for the web to be wound onto reel 11 for transport and/or storage.

Referring to FIG. 2, two such webs 4a and 4b unwind from reels 11a and 11b together with fabric reinforcement 4c from reel 12, and are brought together by rollers 13 to feed onto a porous belt 14. Webs 4a, 4b and fabric 4c comprising a composite web 15 are conveyed by belt 14 through hydroentangling jets 16, and water from the jets is drawn through web 15 and porous belt 14 by vacuum box 17. Water rebounding from the surface of the composite web is collected in trays 18 and conveyed away as described more fully in the prior application.

For complete hydroentanglement the composite web is passed through a plurality of successive hydroentanglement stages, one or more of which may incorporate a screen applied over the surface of the web 15. Hydroentanglement stages are arranged so that jets can be applied to both surfaces of the web, and for the present example, such application of jets is on alternate sides through 5 such stages at a speed of 10 m/min.

In this example perforated screens with an open area of approximately 60% made from chemically etched stainless steel of the type described in the prior application are applied to each side of the web for the final stage of hydroentangling in order to mask the furrow marks from the jets. To prevent coincidence lines forming on the surface, the pitch of the apertures of the screen is made the same as the pitch of the jet orifices.

Jet orifices for this example are 140 microns at 0.9 mm centres, and when applied through the screens, jet pressures can be at the maximum normally available in commercial hydroentangling equipment at 200 bar. Pressures without the screen may be reduced slightly to 180 bar, and unlike similar webs without a bicomponent network, this same high pressure can be applied at the first stage of hydroentangling without the need for an external screen. The resulting hydroentangled web may be finished by impregnating with emulsified oils, pigments and pigment fixatives as may be applied to natural leather, followed by drying and buffing both sides. The side that received three hydroentangling stages (and therefore has a higher degree of entanglement and attachment to the reinforcing fabric) dan then be coated with a leather-like finish by conventional means as used for coating synthetic leather.

The foregoing procedures may be suitable for shoe material, but for un-coated materials such as for clothing suede, web 4 may be on one side only of the reinforcing fabric and four hydroentangling stages applied, all onto the side having the web. After buffing and impregnation the web face may be treated with hot air to cause the projecting manmade fibres to melt and the surface brushed to remove any slight charring leaving a finish closely similar to natural leather.

The resulting sheet material is a high quality reconstituted leather having an excellent feel, strength and surface finish.

It is of course to be understood that the invention is not intended to be restricted to the details of the above embodiment which are described by way of example only.

Thus, for example, the web may be wet laid, although there can be disadvantages with this.

As described in the prior patent application, webs can be wet laid by methods normally used for paper making or by carding if sufficiently long textile fibres are included to carry the leather fibres through the carding process. The use of bicomponent fibres which are added or which make up the carrier fibres provides a “screen” for hydroentangling according to the present invention. For effective carding, normally over 5% of 1.7 decitex carrier fibres of 20 mm or more is needed, and the leather fibres need to be made by textile reclaiming methods to be long enough to avoid excessive ejection of fines. For wet laying, the bicomponent fibres need to be short and the webs dried before fusing. This may not be wholly satisfactory when the next step is to wet the webs again for hydroentangling, while the disadvantages of carding include slow rates of production and wastage from the ejection of fine fibres.

A wide variety of variations are feasible within the scope of this invention. Jet orifice size, screen details, production speeds and other details provided in the prior application can broadly apply to the present invention. The main departure is the reduced application of surface screens, and to ensure good attachment to the reinforcing core, it is often desirable to hydroentangle on alternate sides of the fabric so that fibres are pushed evenly into the interstices of the fabric. Also, due to the stabilising effect of the bicomponent network, pressures can be higher and leather fibres shorter than in the method of the prior application.

Product compositions can vary widely and thickness of the web between the final coated surface and the internal reinforcing layer can differ substantially from the web forming the back layer. For example, instead of the equal webs implied in the previously described example, the front one may be 150 g/m2 and contain 15% non-bicomponent synthetic fibres and the back may be 250 g/m2 and contain 0% of non-bicomponent fibre. The bicomponent content for both webs, however, may be constant at 4%.

Fibre lengths can be determined largely by the production limitations of commercial web laying equipment and, where alternative web laying equipment (such as carding) can handle long manmade fibres, it may not be necessary to incorporate fabric reinforcement. Also, where jet markings are acceptable in the finished product, there may be no need for surface applied screens. Alternatively, screens may be used extensively to supplement the internal screens of the bicomponent network, particularly if the latter are very light and the leather fibres are particularly short.

Hydroentangling speeds can vary widely depending on a whole range of parameters, including weight per unit area of material being hydroentangled, open area of fabric reinforcement, jet pressures, jet diameter, jet spacing, number of passes through the jets, weight of bicomponent network, type of leather fibre, number of passes using external screens, and open area of screens. Generally lighter webs can be hydroentangled at faster speeds, and typically 600 g/m2 material may require 6 m/minute while 200 g/m2 may entangle fully at 15 m/min.

The choice of using relatively long waste leather fibres made by textile reclaiming methods or short ones made by milling (such as conventional hammer or disk milling) can depend on the cost and availability of the different types of waste leather. Milling is cheaper and can use waste leather shavings, which are usually cheaper than the sheet waste used in textile reclaiming plant. However end product quality can be lower and more costly manmade fibre additions may be needed to achieve acceptable performance. Blends of both types of waste fibre can also be used for intermediate quality products.

As with the prior application, the main limitation in weight of composite webs that can be hydroentangled is the onset of hydroentanglement itself as this reduces permeability to the jets and constricts further entanglement. Such constriction is far greater with leather fibres than conventional synthetic fibres but, by using the methods of this invention, it is possible to make acceptable product at relatively high composite web weights of around 600 g/m2. Producing acceptable quality end product at much above this weight is possible but becomes increasingly difficult. Lighter webs are easier to hydroentangle, and minimum web weights can be set more by limits of web forming accuracy and limited market demand for exceptionally thin leather products.

The inter-relationships between all the foregoing parameters are complex and can vary considerably for different types of end product. An optimum balance between output rate, cost and finished product performance can be established by conducting empirical trials within the broad guidance provided in this patent application. The bicomponent network and associated features of the present invention assist considerably in improving production rate and product quality at lower cost compared to the methods of the prior application.

1. A method of forming a sheet material from a mixture of fibres comprising base fibres and additional synthetic fibres, said additional synthetic fibres having outer meltable layers, comprising the steps of:
forming the fibres into a web,
heating to melt the outer layers of the additional synthetic fibres so as to cause such fibres to fuse together at intersections to form a network within the web, and
subjecting the web to entanglement to entangle the base fibres while constrained by the network.

2. The method according to claim 1 wherein the base fibres are leather fibres.

3. The method according to claim 13o 2 wherein the said entanglement comprises hydroentanglement.

4. A method of forming a sheet material from a mixture of fibres comprising leather base fibres and additional synthetic fibres, said additional synthetic fibres having outer meltable layers comprising the steps of:
forming the fibres into a web having and outer surface,
heating to melt the outer layers of the additional synthetic fibres so as to cause such fibres to fuse together at intersections to form a network within the web, and
subjecting the web to hydroentanglement to entangle the leather fibres while constrained by the network.

5. The method according to claim 4 wherein the hydroentanglement is performed with high pressure jets of liquid which penetrate the network.

6. The method according to claim 4 wherein the hydroentanglement is performed with high pressure jets of liquid applied from the opposite sides of the web.

7. The method according to claim 4 wherein the hydroentanglement is performed with high pressure jets of liquid and a water receiving structure is provided to receive bounced back liquid.

8. The method according to claim 4 wherein the entanglement is performed using high pressure jets of liquid in multiple passes.

9. The method according to claim 5 wherein the liquid is water.

10. The method according to claim 8 wherein the hydroentanglement is performed with a screen or screens between the web and the jets in at least one said pass.

11. The method according to claim 10 wherein the screen is at least 60% open.

12. The method according to claim 10 wherein the screen has openings with a pitch angle the same as the angle of the jets to the web.

13. The method according to claim 10 wherein the screen or screens is such as to substantially prevent formation of furrows by the hydroentanglement jets.

14. The method according to claim 4 wherein the hydroentanglement is performed with the web advancing at a speed greater than 6 m/min.

15. The method according to claim 4 wherein at least 90% of the base fibres have a maximum fibre length of 6 mm.

16. The method according to claim 4 wherein the additional synthetic fibres have a maximum fibre length of 10 mm.

17. The method according to claim 4 wherein the additional synthetic fibres constitute 2-10% of the weight of the mixture of fibres.

18. The method according to claim 4 wherein the additional synthetic fibres constitute up to 5% of the weight of the mixture of fibres.

19. The method according to claim 4 wherein the additional synthetic fibres are in the range 1.7 to 3.0 dtex.

20. The method according to claim 4 wherein the additional synthetic fibres are bicomponent fibres having one or more outer meltable layers with a melting point lower than the melting point of an inner core thereof.

21. The method according to claim 20 wherein the one or more outer layers are polyethylene and the inner core is polyester or polypropylene.

22. The method according to claim 4 wherein the said mixture of fibres also includes further synthetic fibres which are not melted to fuse together.

23. The method according to claim 22 wherein the further synthetic fibres are less than 1.0 dtex.

24. The method according to claim 22 wherein the further fibres comprise 5-20% by weight of the sheet material.

25. The method according to claim 4 wherein the leather fibres have lengths of less than 3 mm.

26. The method according to claim 4 wherein the outer meltable layers of the additional synthetic fibres are melted by passing hot air through the web.

27. The method according to claim 26 wherein the web is held between porous belts during passage of the hot air through the web.

28. A The method according to claim 4 wherein the outer surface of the entangled web is subjected to heat to melt said additional synthetic fibres at said outer surface.

29. The method according to claim 4 wherein the outer surface of the entangled web is buffed.

30. The method according to claim 28 wherein the outer surface of the entangled web is buffed before said heating of the outer surface of the web.

31. The method according to claim 4 wherein first and second separate webs are united on opposite sides of a reinforcing fabric prior to entanglement.

32. The method according to claim 31 wherein the said base fibres are entangled with the reinforcing fabric.

33. The method according to claim 4 wherein the web is wound on a reel after formation of the network, and the web is drawn from such reel to be subjected to said hydroentanglement.

34. The method according to claim 4 wherein the fused intersections of the network are at least partially disrupted by the entanglement.

35. The method according to claim 4 wherein the network is predominantly open whereby solid parts of the network make up a minor proportion of its structure.

36. The method according to claim 4 wherein the said mixture of fibres is compressed after melting of the additional synthetic fibres but before they have fused together and solidified at the intersections.

37. The sheet material formed using the method of claim 4.

38. A sheet material comprising at least one body of entangled fibres comprising leather base fibres wherein an openwork structure extends within the body so as to be penetrated by the leather base fibres, said openwork structure being defined by a network of additional synthetic fibres fused together at intersections thereof, and wherein the network makes up a minor proportion by weight of the sheet material.

39. The sheet material according to claim 38 wherein the leather base fibres have a maximum fibre length of 6 mm.

40. The sheet material according to claim 38 wherein 90% of the additional synthetic fibres have a maximum fibre length of 10 mm.

41. The sheet material according to claim 38 wherein the additional synthetic fibres constitute 10% of the weight of the sheet material.

42. The sheet material according to claim 41 wherein the additional synthetic fibres constitute up to 5% of the weight of the sheet material.

43. The sheet material according to claim 38 wherein the additional synthetic fibres are bicomponent fibres having one or more outer layers with a melting point lower than the melting point of the inner core thereof.

44. The sheet material according to claim 43 wherein the one or more outer layers are polyethylene and the inner core is polyester or polypropylene.

45. The sheet material according to claim 38 wherein the additional synthetic fibres are in the range 1.7 to 3.0 dtex.

46. The sheet material according to claim 38 wherein the said body of entangled fibres also includes further synthetic fibres which are not melted to fuse together.

47. The sheet material according to claim 38 wherein the further synthetic fibres are less than 1.0 dtex.

48. The sheet material according to claim 46 wherein the further synthetic fibres make up less than 20% by weight of the sheet material.

49. The sheet material according to claim 38 wherein the leather fibres have lengths of less than 3 mm.

50. The sheet material according to claim 38 wherein the network is predominantly open whereby solid parts of the network make up a minor proportion of its structure.

51. The sheet material according to claim 38 comprising two said bodies united on opposite sides of a fabric layer.

52. The sheet material according to claim 51 wherein the said leather fibres penetrate the fabric layer.

53. The sheet material according to claim 51 wherein at least one body contains a higher proportion of said further synthetic material adjacent the reinforcing layer than at the outer surface thereof.
